(19) United States
(12) Patent Application Publication
(10) Pub. No.: US 2013/0340374 A1
(43) Pub. Date: Dec. 26, 2013

(54) Pergola Structure

(71) Applicant: Shahar Salomon, Gedera (IL)

(72) Inventor: Shahar Salomon, Gedera (IL)

(21) Appl. No.: 13/916,989

(22) Filed: Jun. 13, 2013

(30) Foreign Application Priority Data
Jun. 26, 2012 (IL) 220654

(51) Int. Cl. E04F 10/08; B27M 3/02

(52) U.S. Cl. CPC E04F 10/08; B27M 3/02
USPC 52/650.3; 144/137

(57) ABSTRACT

A pergola structure (10), comprising: at least one horizontal rafter (28), comprising a plurality of tilted notches (22) at the top (32) thereof; and a plurality of parallel horizontal purlins (34), each inserted into the tilted notches (22) from above, thereby each of the purlins (34) is disposed at two sides (12A, 12B) of the rafter (28), providing a firm roof, while allowing flow of air and light therethrough.

### CROSS REFERENCE TO RELATED APPLICATION

This application claims priority to Israel Patent Application No. IL 220654 filed Jun. 26, 2012; this application is hereby incorporated by reference herein as if fully set forth in its entirety.

### FIELD OF THE INVENTION

The present invention relates to the field of pergola structures. More particularly, the invention relates to a notched beam and a method for constructing a pergola.

### BACKGROUND OF THE INVENTION

The term “purlin” refers herein to a beam for providing shading of a roof

Presently, the following structures are known to install pergola purlins:

Method A: Involves using a diagonally cut purlin (wooden beam) that rests on the rafters (main pergola crossbeams) and attached using a screw or nail.

The disadvantages to this method are:

It requires a long installation time

The builder installs the pergola from the pergola roof, which is unsafe. The installer has no support on the pergola roof, as it is not yet fully built.

It is extremely difficult to change the angle of the beams.

Beyond 45°, the beam will not be supported for a long time on the rafters.

It is virtually impossible to add a plastic or other covering against rain to the pergola in this configuration.

Method B: Referring to FIG. 3, the current method, disclosed in Israel Design No. 33765, is to fix notched beams 20 on the sides of the rafters 14 (main pergola crossbeams). After fixing the notched beams 20 to the rafters 14, the purlins 16 must be cut very accurately to ensure they fit between the main rafters 14. Purlins 16 and then placed, each between two rafters 14.

Thus, the rafters 14 support only the end of each purlin 16. If the purlin 16 is cut too short, then the support by rafter 14 is very weak since the supported length is shortened. If the purlin 16 is cut too long the purlin 16 cannot be inserted between the two rafters 14.

The disadvantages to this method are:

It requires a long installation time.

High costs are incurred, as it uses more material.

Over time, if the rafters twist or warp slightly due to deformations caused by weather, the purlins can fall, as they are supported by the rafters, rest on a 1-1.5 cm wide shelf.

If someone needs, for any reason, to climb to the roof of the pergola, this can be dangerous.

All the methods described above have not yet provided satisfactory solutions to the problem of pergola construction.

It is an object of the present invention to provide a solution to the above-mentioned and other problems of the prior art.

Other objects and advantages of the invention will become apparent as the description proceeds.

### SUMMARY OF THE INVENTION

The present invention relates to a method that uses a notched rafter 28 to install and create a pergola, and to provide a solution to the problems with currently existing methods.

Referring to FIG. 4, a notched rafter 28 is used instead of the two notched beams 20 fixed to the rafters 14 of the prior art method B of FIG. 3, and thus allows:

Fast installation with no need to climb onto the roof. The purlins 34 of the present invention are assembled for the most part along the length of the pergola all at once.

It is easy to assemble and cover the pergola, e.g. with a plastic cover, as the top 38 of purlins 34 resides at the same height of the top of the notched rafter 28. This is safer and stronger e.g. in the case of standing on purlins 34.

This method allows for relatively easier assembly and disassembly to allow painting the top of the pergola, constituting the top 38 of purlins 34 and the top of the notched rafter 28 every few years to protect the pergola from weather damage.

Referring to FIG. 6, in the pergola structure 10 of the present invention, purlins 34 can be attached either at their ends, or they can also have support at the center. There is no need to fit each purlin 34 to the location of notched rafter 28. Using the current method, the length of purlin 34 does not depend on the distance between rafters 28, and thus there is no need for perfect accuracy in the measurements of the lengths of purlin 34, as the purlins 34 are mostly connected along most of the length of the pergola or the entire length of the pergola at once.

Referring to FIG. 4, in this invention, the diagonal notches 22 are produced on the rafter 28 using a fully automated machine. The bottom end shape 36 of the purlins 34 matches the shape of the notches 22 in the rafters 28.

Referring to FIG. 7, the rafters 28 are produced by a dedicated, fully automated machine 42. The machine 42 includes a rotating drill or molder 44 having a fixed head (not movable) 46. Molder 44 cuts within the rafter 28 producing the notches 22. A cart 52 moves to and fro diagonally along diagonal rails 54 toward the molder 44, thus the rafter 28 beam moves at the desired angle relative to the molder 44.

The rafter 28 is transported at constant intervals on the cart.

The machine moves rafter 28 by a pin 62 having substantially the same diameter of the molder drill 44 that has formed the notch 22 in the rafter 28. The pin 62 enters the notch 22 and pulls the rafter 28 forward, one step at a time, at a distance bringing molder drill 44 to the next location for producing the next new notch 22.

The machine 42 contains a controller, pistons, trackers, wheels and motors that allow the beam to move at fixed distances and fixed angles while producing the notches 22 by moving the molder 44. The angle and distance between each notch 22 can be changed by changing parameters of the machine 42.

Rationale

The Problem: Often the pergola purlins 34 must be cleaned or painted from above; or from time to time a person must climb onto the roof to remove an item that has fallen thereonto. The prior art configuration of the pergola building as described in FIGS. 1 to 3 does not allow safe standing on the roof thereof, since purlins 16 might bend due to the support at the ends only as depicted in FIG. 3. As well, the top surface of purlins 16 is serrated and uneven as depicted in the magnified view of FIG. 2.

The solution the present invention provides in the pergola structure 10 according to the present invention is that purlins 34 of the present invention are supported by notched rafter 28 also at the center thereof, as depicted in FIG. 6. In addition, the purlins 34 are formed flat at the top 38 thereof, as depicted in FIG. 4, even though the beams are tilted at an angle of about 45%. The flat top 38 of purlins 34 inserted into notches 22 of rafter 28, combined with the flat top surface of the rafter 28, form a smooth surface 40, as depicted in FIG. 5.

The advantages of the purlins 34 of the present invention are:

Purlins 34 form a flat top surface 40.

The purlins 34 occupy about 45% of the surface, as depicted in FIG. 6, allowing both to stand on the pergola roof and in spite of this, entrance of light and air to flow through the gaps between the purlins 34.

### BRIEF DESCRIPTION OF THE DRAWINGS

Embodiments and features of the present invention are described herein in conjunction with the following drawings:

FIG. 1 shows a perspective sketch of a pergola built using method A of the prior art knowledge.

FIG. 2 shows a two-dimensional sketch of a side view of the prior art pergola of FIG. 1.

FIG. 3 shows a perspective sketch of a pergola built using method B of the prior art knowledge.

FIG. 4 shows a two dimensional sketch of a side view of the main rafter and the purlins prior to their insertion into the notches of the rafters in accordance with one embodiment of the current invention.

FIG. 5 shows a two-dimensional sketch of a side view of the main rafter and the purlins of FIG. 4 after their insertion into the notches in the rafter.

FIG. 6 shows a perspective sketch of a pergola of FIG. 4 built.

FIG. 7 shows a perspective sketch of a machine according to one embodiment of the present invention, for producing the notches in the notched rafters when the rafters are being moved to a next area.

FIG. 8 shows a perspective sketch of the machine of FIG. 7 during the cutting.

It should be understood that the drawings are not necessarily drawn to scale.

### DETAILED DESCRIPTION OF INVENTION

The present invention will be understood from the following detailed description of preferred embodiments, which are meant to be descriptive and not limiting. For the sake of brevity, some well-known features, methods, systems, procedures, components, circuits, and so on, are not described in detail.

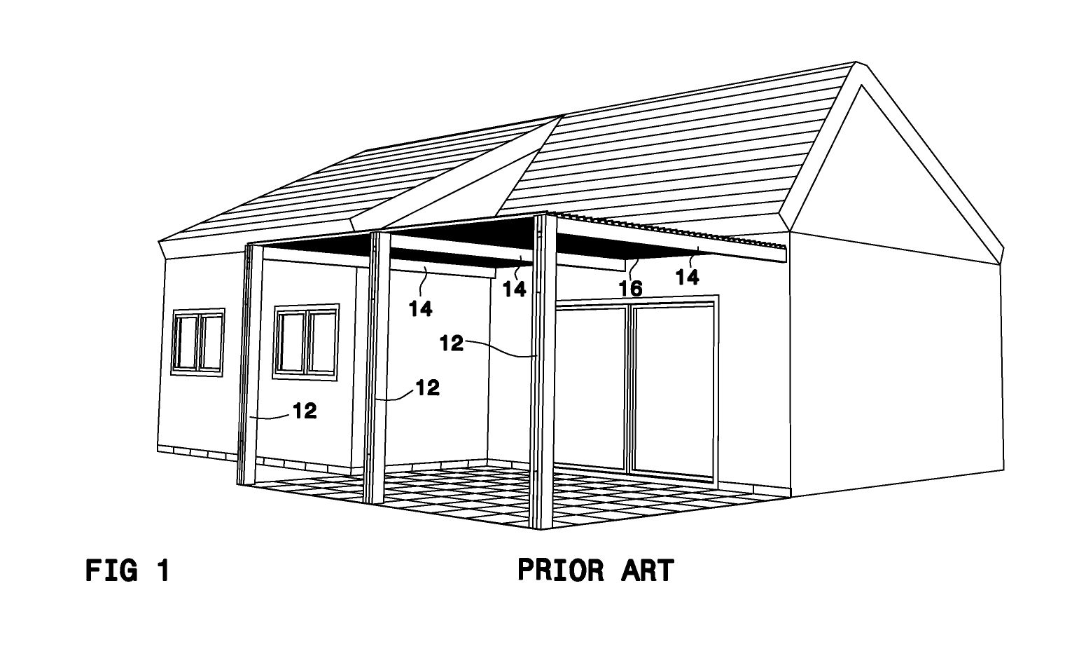

FIG. 1 shows a perspective sketch of a pergola built using method A of the prior art knowledge.

This prior art configuration is the most popular configuration, because of the relatively low cost of materials and work required.

In this configuration, the horizontal rafters (14) are affixed between the base vertical posts (12) and the wall. The beams/purlins (16) are attached to the top of the horizontal rafters at an angle of about 45° relative to the horizontal rafters (14).

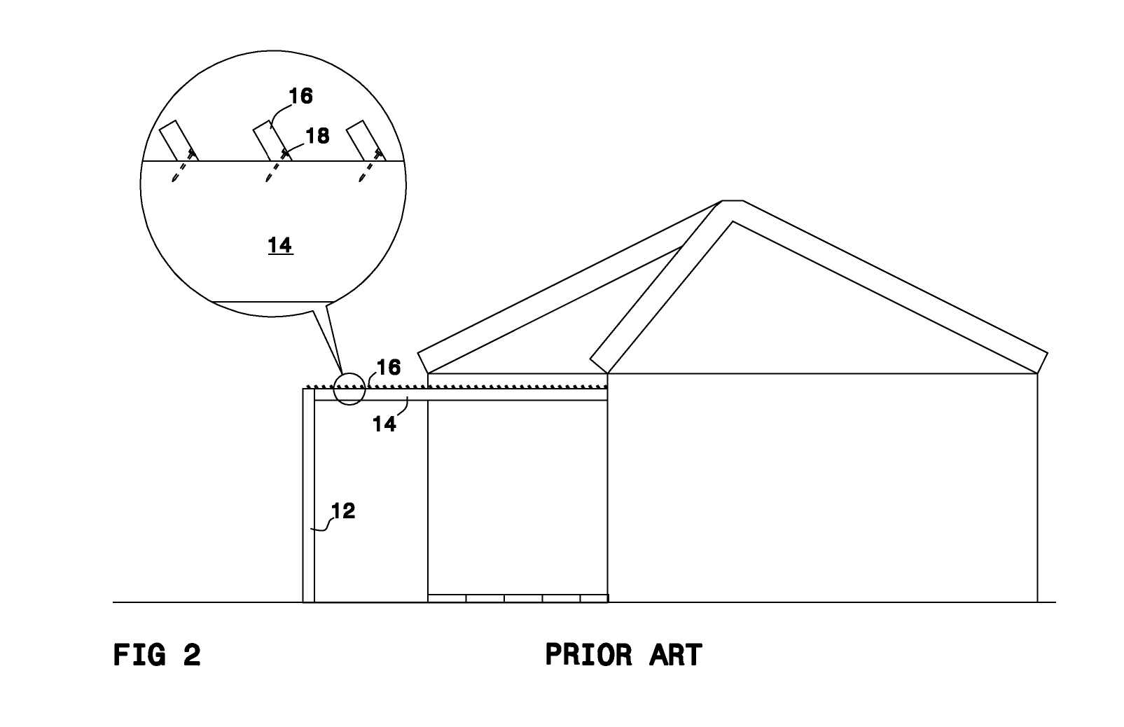

FIG. 2 shows a two-dimensional sketch of a side view of the prior art pergola of FIG. 1.

The bottom section of the beams (16) is sawn diagonally for forming a surface being parallel to the surface of the horizontal rafter (14).

The connection between the bottom surface of beams (16) and the horizontal rafter (14) is performed by threading a nail and a screw (18). This connection is disadvantaged of not allowing disassembling the beams (16) from the horizontal rafter (14).

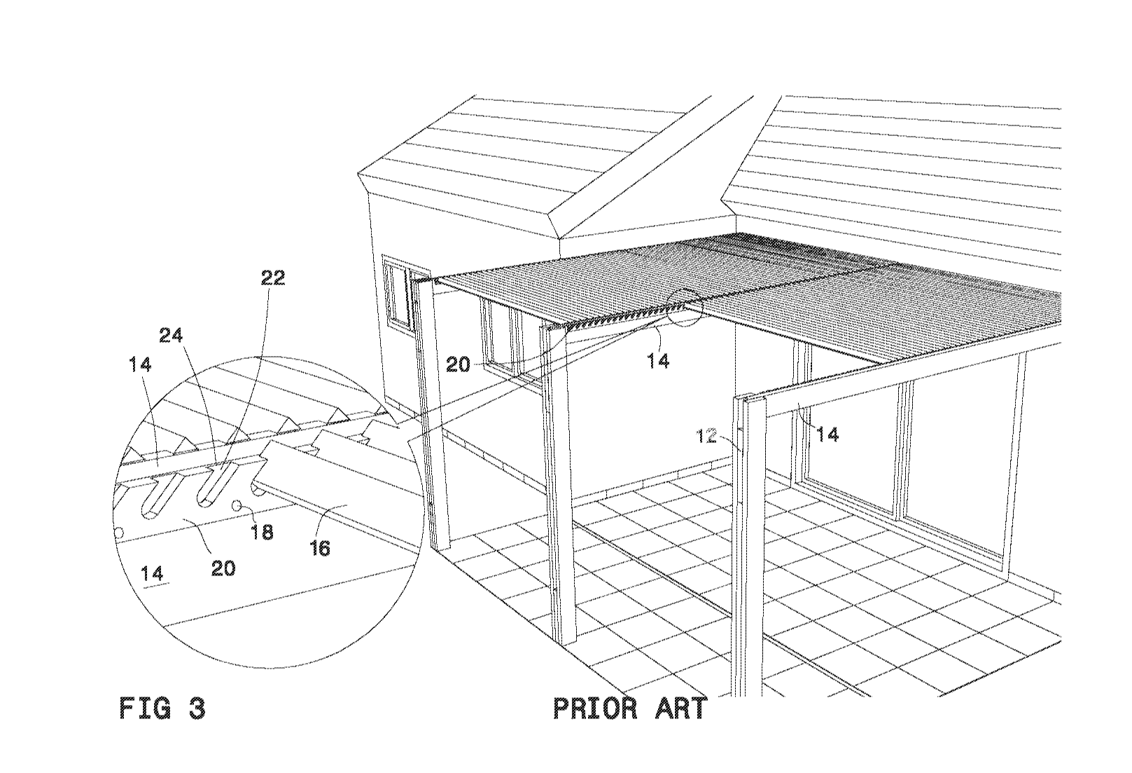

FIG. 3 shows a perspective sketch of a pergola built using method B of the prior art knowledge.

In this configuration, the vertical beam (12) and the horizontal rafter (14) are identical to those of FIGS. 1 and 2; and the affixing is also identical.

A notched beam (20) is mounted to the side of the horizontal rafter (14), by nails or screws (18), in parallel along the entire length of the notched beam (20). This notched beam (20) has notches (22). Each notch (22) ordinarily extends into a part of the notched beam (20) width, whereas the end (24) behind the notch (22) while one is uncut (24). The notches in the notched beam (20) are tilted for insertion of the beams (16) at a tilted position. According to one embodiment, after insertion of the beams (16), the notched beam (20) is firmly fixed using nails or screws.

The disadvantage to this configuration is the high cost of assembly and of materials.

The critical disadvantage is the high precision needed for assembly, and the risk that the beams will fallout their positions as a result of slight deformations over time of the beams (16), since the depth of the notches (22) that holds the beams (16) is very small (about 15 cm deep). The beams (16) cannot support any significant weight, and thus a person cannot stand of the beams (16).

Another disadvantage to this method is that the beams cannot protrude beyond the rafters.

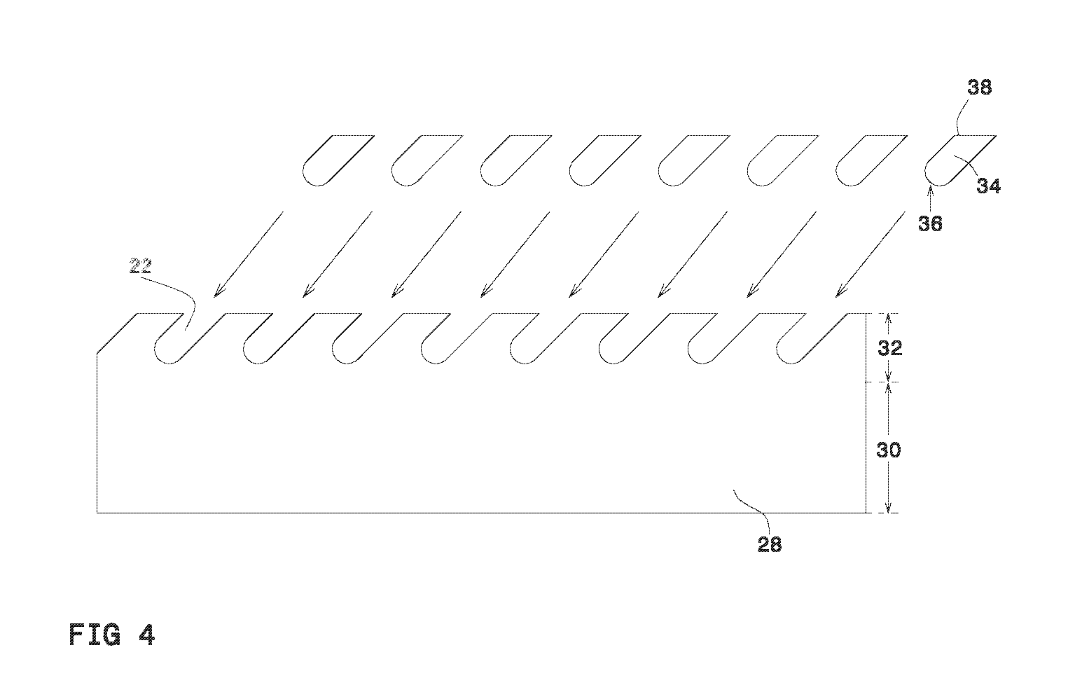

FIG. 4 shows a two dimensional sketch of a side view of a notched rafter and the purlins prior to their insertion into the notches of the notched rafter, in accordance with the current invention.

In the current invention, the horizontal rafter (28) of the pergola (10) is wider than that of the prior art notched beam (20) of method B. The bottom section (30) of the rafter (28) is used as a strong support, and the top section (32) includes diagonal notches used to hold the purlins (34). Thus the rafter (28) is a notched rafter.

In this configuration, the purlins (34) are rounded at the bottom portion (36) or shaped otherwise to fit into the notch (22) of the notched beam (28).

The purlins (34) are truncated at the top (38), such that a plurality of purlins (34) form a flat surface after their insertion into the notched rafter (28).

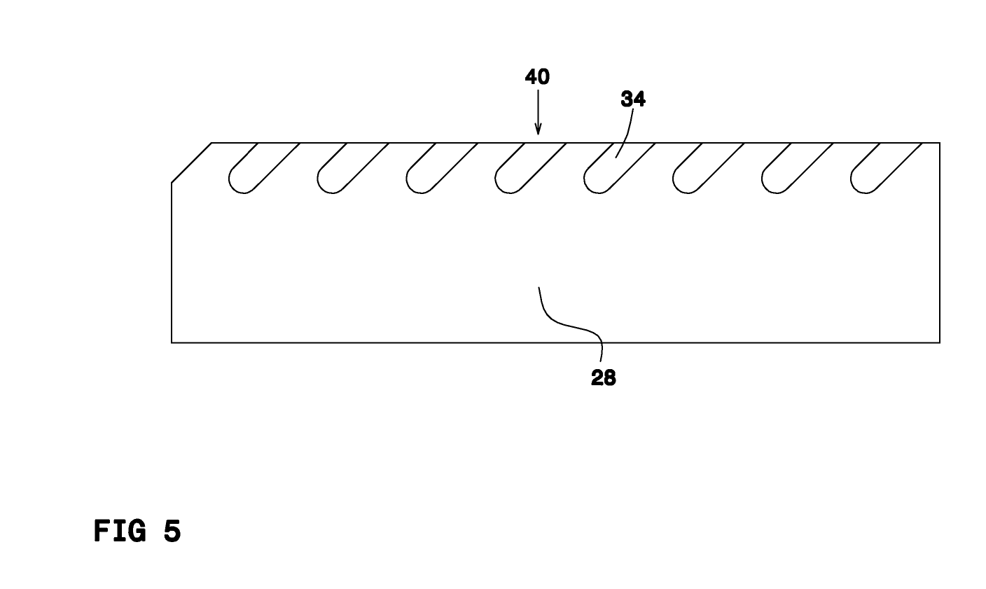

FIG. 5 shows a two-dimensional sketch of a side view of the main rafter and the matching purlins after insertion into the notches in the rafter in accordance with the current invention.

After insertion of the purlins (34) into the notched rafter (28), a smooth surface (40) is obtained, thus allowing covering the surface with an additional protective layer over the pergola, e.g. plastic sheeting to protect against rain.

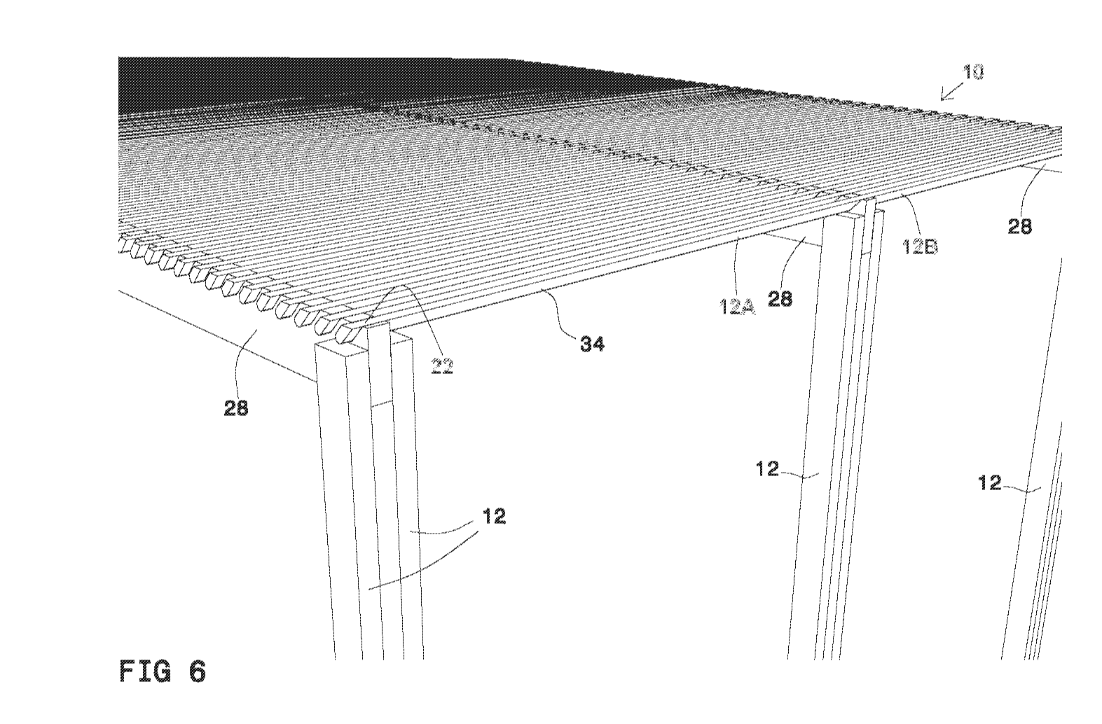

FIG. 6 shows a perspective sketch of a pergola structure assembled in accordance with the current invention.

In the pergola structure (10) according to the present invention, the vertical beams (12) support the notched horizontal rafters (28), into which the purlins (34) are inserted.

In contrast to the prior art structure of method B depicted in FIG. 3, each purlin (34) in the inventive pergola structure (10) of FIG. 6 is disposed at both sides of the vertical beam (12), namely side 12A and 12B, and thus is disposed at both sides of the notched rafter (28). Thus, deformation of the purlins (34) does not weaken the support thereof by the notched rafter (28). A person thus may stand on the beams (34) without any risk, since purlins (34) form a firm roof.

In contrast to method B of the prior art depicted in FIG. 3, where the notches (22) and the notched beam (20) are disposed at the side of the rafter (14), according to the present invention the notches (22) are disposed on top on the notched rafter (28), thus the notches (22) protrude from the rafter (28). This inventive structure provides the advantage of the disposition of each beam (34) at both sides of the notched rafter (28)

Smooth surface (40) is formed for utilizing this feature of allowing a person stand on the beams (34). The smooth surface (40) includes longitudinal spaces between the beams (34), for allowing entrance of air flow, sun, and rain.

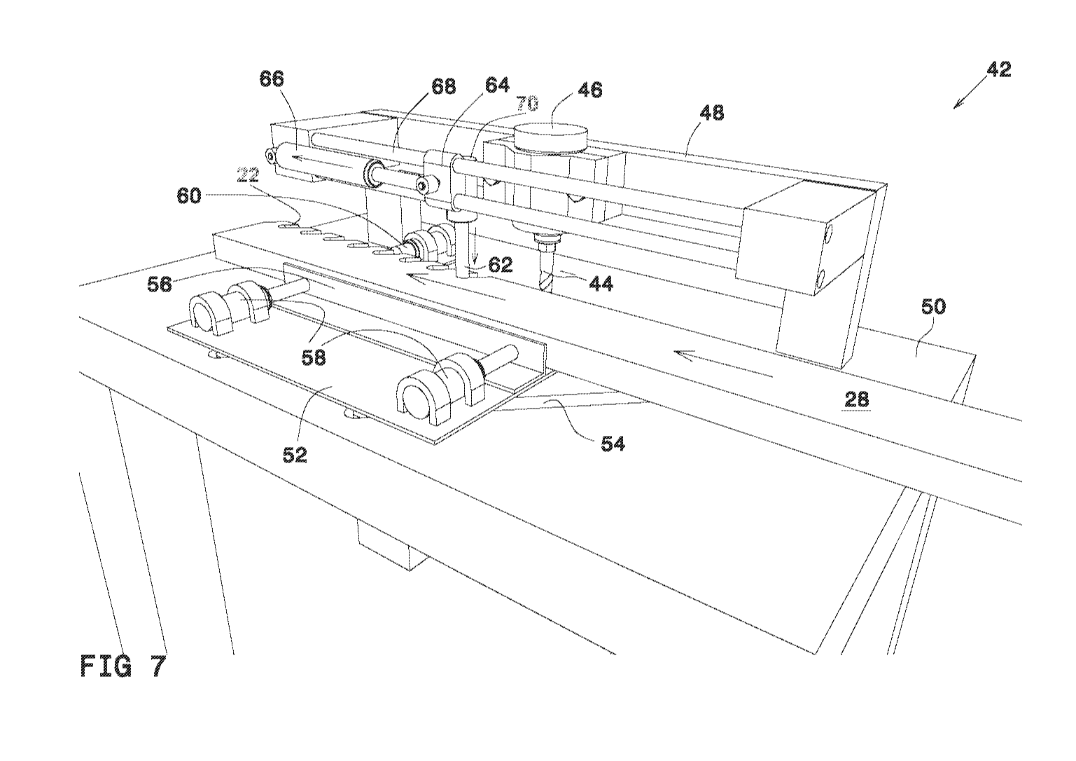

FIG. 7 shows a perspective sketch of a machine according to one embodiment of the present invention, for producing the notches in the notched rafters when the rafters are being moved to a next area.

The machine (42) produces the notched rafter (28) from a raw plate (28). The machine (42) moves the plate (28) at pre-determined constant intervals, cutting at each interval a notch (22) from the plate (28) by a stationary molder (44), after moving the plate (28) in relation to the stationary molder (44).

The molder (44) is connected to an electric motor (46), which is fixed permanently to a stationary bridged structure (48).

The bridge structure (48) includes horizontal rails (68) along which a pin moving element (64) moves left and right by a horizontal piston (66). The plate is mounted to a vertical piston (70) for raising and lowering a pin (62) up and down.

The horizontal piston (66) thus moves the pin moving element (64) left and right. Thus, the pin (62) may move in two axes: up and down, and left and right.

At the first step, the pin (62) catches the last notch (62) produced by the molder (44). At the second step the pin (62) moves the last notch (22) to the left, by the pin moving element (64) in a pre-determined distance. At the third step the pin (62) is removed from the plate (28).

When the molder (44) cuts a notch (22), a vise (56) operated by motion pistons (58) from one side and locking pistons (60) from the other side, grips the plate (28), for moving the plate (28) in relation to the stationary molder (44). When the pin (62) moves the plate (28), the vise (56) releases the grip on the plate (28), by releasing the locking pistons (60).

The vise (56), the motion pistons (58) and the locking pistons (60) are a part of the cart (52) on which the raw plate (28) is placed. This cart (52) moves along diagonal rails (54), which enable the entire raw plate (28) to move towards the molder (44) which cuts the raw plate (28), and through which the diagonal notch (22) is formed.

After the cutting, the vise (56) releases the raw plate (28) again, and the pin (62) once again moves the wood to the next zone for cutting.

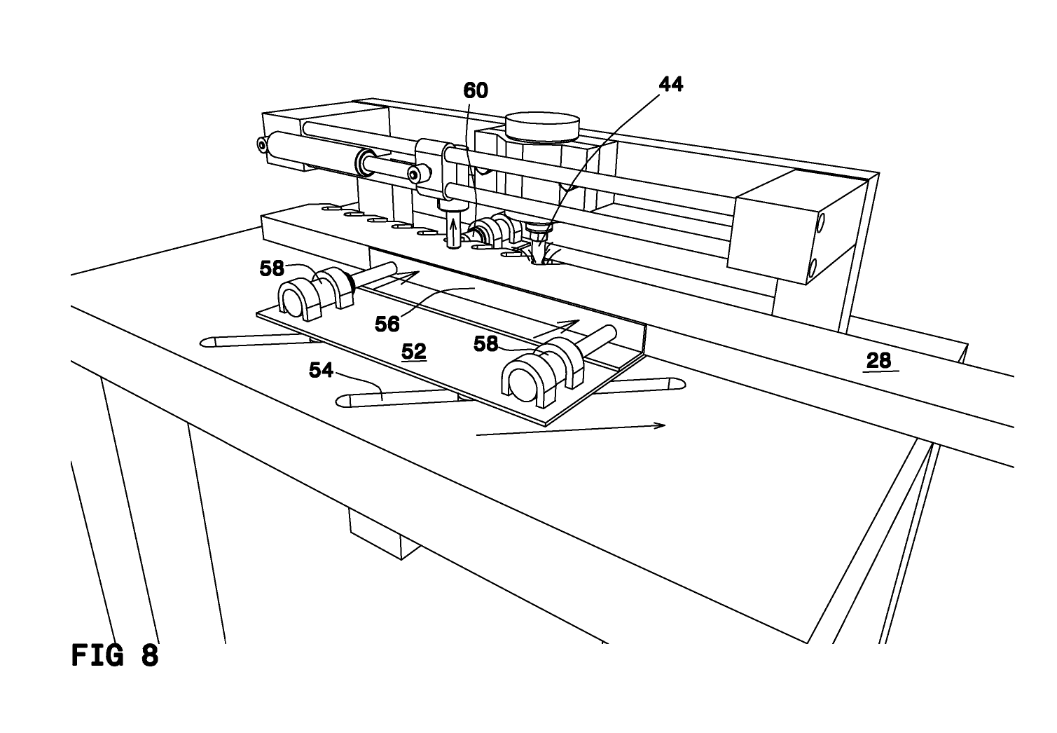

FIG. 8 shows a perspective sketch of the machine of FIG. 7 during the cutting.

When being cut, the raw plate (28) is gripped by the vise (56) that operated by pistons (58) and (60). Locking pistons (60) lock the raw plate (28). The cart (52) moves along the track (54) diagonally, bringing the raw plate (28) toward the molder (44), thus cutting a diagonal notch (22) in the raw plate (28).

In accordance with the current invention, the angles of movement of the cart rails (54) may be adjusted, and thus the angle of the cut in the raw plate (28), being the notched rafter (28) may vary, to allow different fractions of light to enter through the pergola, and alter the amount of shade the pergola provides.

In the figures and/or description herein, the following reference numerals have been mentioned:

numeral 10 denotes a pergola structure according to one embodiment of the present invention;

numeral 12 denotes a vertical beam for supporting the notched rafter;

numerals 12A and 12B denote two sides of the vertical beam, for showing that the purlins to two sides;

numeral 14 denotes a prior art rafter;

numeral 16 denotes a prior art purlin;

numeral 18 denotes a screw and/or a nail;

numeral 20 denotes a prior art notched beam;

numeral 22 denotes a notch in a notched beam;

numeral 24 denotes an uncut portion in the prior art notched beam;

numeral 28 denotes a notched rafter of the present invention;

numeral 30 denotes the bottom section of the notched rafter of the present invention;

numeral 32 denotes the top section of the notched rafter of the present invention;

numeral 34 denotes a purlin of the present invention;

numeral 36 denotes the bottom portion of the purlin;

numeral 38 denotes the top portion of the purlin;

numeral 40 denotes a smooth surface formed by the top portions of the purlins;

numeral 42 denotes a machine for producing the notched rafter of the present invention;

numeral 44 denotes a molder or a drill, for producing the notches of the notched rafter;

numeral 46 denotes an electric motor;

numeral 48 denotes a bridged structure of the machine;

numeral 52 denotes a cart for moving the raw plate;

numeral 54 denotes a rail, along which the raw plate;

numeral 56 denotes a vise for gripping the raw plate;

numeral 58 denotes a piston for moving the raw plate;

numeral 60 denotes a piston for locking the raw plate;

numeral 62 denotes a pin for catching a notch;

numeral 64 denotes an element for moving the pin;

numeral 66 denotes a horizontal piston for moving the pin horizontally;

numeral 68 denotes a horizontal rail; and

numeral 70 denotes a vertical piston.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A pergola structure (10), comprising:
at least one horizontal rafter (28) comprising a plurality of tilted notches (22) at the top (32) thereof; and
a plurality of parallel horizontal purlins (34), each inserted into said tilted notches (22) from above,
thereby each of said purlins (34) is disposed at two sides (12A, 12B) of said rafter (28), providing a firm roof, while allowing flow of air and light therethrough.

2. A pergola structure (10) according to claim 1, wherein each of said purlins (34) comprises a flat horizontal top (38),
thereby forming a smooth surface (40).

3. A pergola structure (10) according to claim 1, wherein each of said purlins (34) comprises a bottom (36) shaped to fit to one of said notches (22).

4. A pergola structure (10) according to claim 1, further comprising:
at least two vertical beams (12), for supporting said at least one horizontal rafter (28).

5. A machine (42) for producing a pergola structure (10) according to claim 1, said machine comprising:
a stationary molder (44);
a cart (52), for moving a raw plate (28) diagonally towards said stationary molder (44), for producing notches (22) thereby; and
a pin (62) for catching one of said notches (22) for moving a new zone of said raw plate (28) in front of said stationary molder (44),
thereby said raw plate (28) is formed into said rafter (28).

5. A machine (42) according to claim 4, further comprising:
a vise (56), for gripping said raw plate (28) upon said moving thereof diagonally, and for releasing said raw plate (28) upon said moving said new zone of said raw plate (28) by said pin (62).
